(19) United States
(12) Patent Application Publication
(10) Pub. No.: US 2021/0331675 A1
(43) Pub. Date: Oct. 28, 2021

(54) METHOD OF AND SYSTEM FOR TRANSMITTING A BASIC SAFETY MESSAGE FROM A VEHICLE

(71) Applicant: Nissan North America, Inc., Franklin, TN (US)

(72) Inventors: Andrew DAMIANI, Eastpointe, MI (US); Roy GOUDY, Farmington Hills, MI (US); Neal PROBERT, Farmington Hills, MI (US)

(73) Assignee: Nissan North America, Inc.

(21) Appl. No.: 16/855,138

(22) Filed: Apr. 22, 2020

(51) Int. Cl. B60W 30/16; G08G 1/16; H04W 4/46

(52) U.S. Cl. CPC B60W 30/16; B60W 2556/65; H04W 4/46; G08G 1/161

(57) ABSTRACT

A method of transmitting a vehicle basic safety message includes receiving a basic safety message from each of a plurality of remote vehicles within a predetermined distance of a host vehicle. The basic safety message includes a width and a length of the remote vehicle. At least one of a new width and a new length of the host vehicle is determined. The new width and the new length of the host vehicle are different from an actual width and an actual length of the host vehicle. A new basic safety message is transmitted from the host vehicle including the at least one of the new width and the new length of the host vehicle.

### BACKGROUND

### Field of the Invention

The present invention generally relates to a method of and a system for transmitting a basic safety message from a vehicle. More specifically, the present invention relates to a method of and a system for transmitting a basic safety message from a vehicle in which the basic safety message includes at least one of a new width and length of the vehicle that is different from the actual width and length of the vehicle.

### Background Information

Vehicles are equipped with vehicle-to-anything (V2X) communication to provide low-latency communication between vehicles. V2X communication allows vehicles to wirelessly send and receive a basic safety message. The basic safety message is a packet of data that includes information about the vehicle position, heading, speed, and other information relating to the vehicles state and path history broadcast from a transmitting vehicle. The transmitted information includes the actual width and the actual length of the transmitting vehicle. The received vehicle length and width from the transmitting vehicle can be used to identify the specific make and model of the transmitting vehicle such that the receiving vehicle can identify and track the transmitting vehicle. A need exists to protect the privacy of the vehicle occupants.

### SUMMARY

One object of the disclosure is to provide a method of and a system for transmitting a basic safety message in which at least one of the actual length and the actual width of the vehicle is changed to obfuscate the actual length and/or the actual width of the vehicle, thereby preventing the vehicle from being identified by the transmitted information and protecting the privacy of the vehicle occupants.

In view of the state of the known technology, one aspect of the present disclosure is to provide a method of transmitting a vehicle basic safety message. A basic safety message is received from each of a plurality of remote vehicles within a predetermined distance of a host vehicle. The basic safety message includes a width and a length of the remote vehicle. At least one of a new width and a new length of the host vehicle is determined. The new width and the new length of the host vehicle are different from an actual width and an actual length of the host vehicle. A new basic safety message is transmitted by the host vehicle including the at least one of the new width and the new length of the host vehicle.

Another aspect of the present invention is to provide a system for transmitting a vehicle basic safety message. The system includes a wireless communication system and an electronic controller. The wireless communication system is configured to receive a remote vehicle basic safety message from each of a plurality of remote vehicles within a predetermined distance of a host vehicle. The remote vehicle basic safety message includes a width and a length of the remote vehicle. The electronic controller is configured to determine at least one of a new width and a new length of the host vehicle. The new width and the new length of the host vehicle are different from an actual width and an actual length of the host vehicle. The wireless communication system is further configured to transmit a host vehicle basic safety message including the at least one of the new width and the new length of the host vehicle.

Also other objects, features, aspects and advantages of the disclosed method of and system for transmitting a basic safety message from a vehicle will become apparent to those skilled in the art from the following detailed description, which, taken in conjunction with the annexed drawings, discloses exemplary embodiments of the method of and system for transmitting a basic safety message from a vehicle.

### BRIEF DESCRIPTION OF THE DRAWINGS

Referring now to the attached drawings which form a part of this original disclosure:

FIG. 1 is a block diagram of exemplary components of a host vehicle equipped with a system for transmitting a basic safety message in accordance with an exemplary embodiment of the present invention;

FIG. 2 is a flowchart illustrating changing an actual length and width of the host vehicle for transmission with the basic safety message in accordance with an exemplary embodiment of the present invention;

FIG. 3 is a schematic representation of the host vehicle in a low density environment for transmitting and receiving the basic safety messages;

FIG. 4 is a schematic representation of the host vehicle in a high density environment for transmitting and receiving the basic safety messages; and

FIG. 5 is a schematic representation of an adjusted length and width of the host vehicle to be transmitted with the basic safety message.

### DETAILED DESCRIPTION OF EXEMPLARY EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

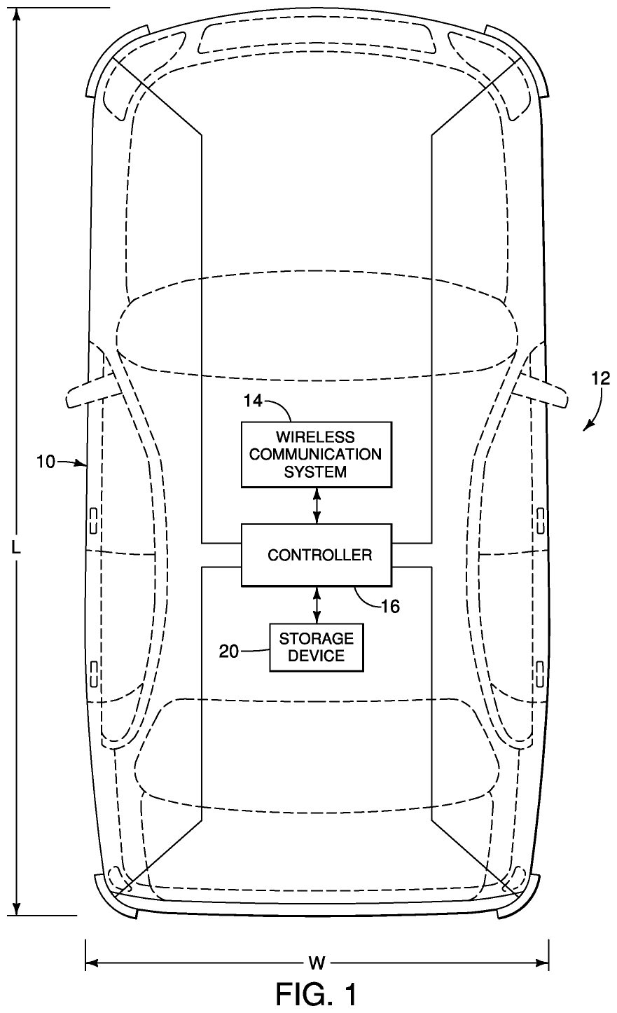

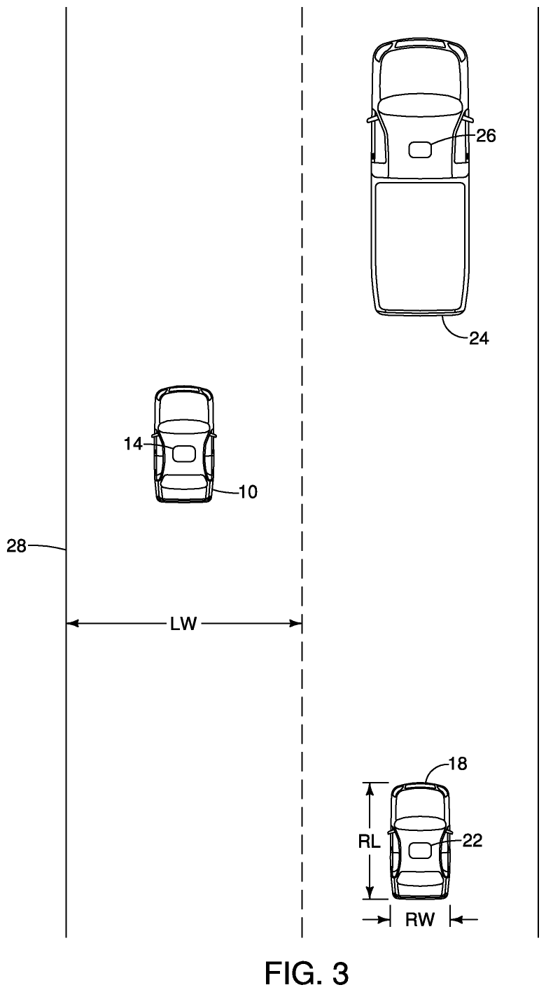

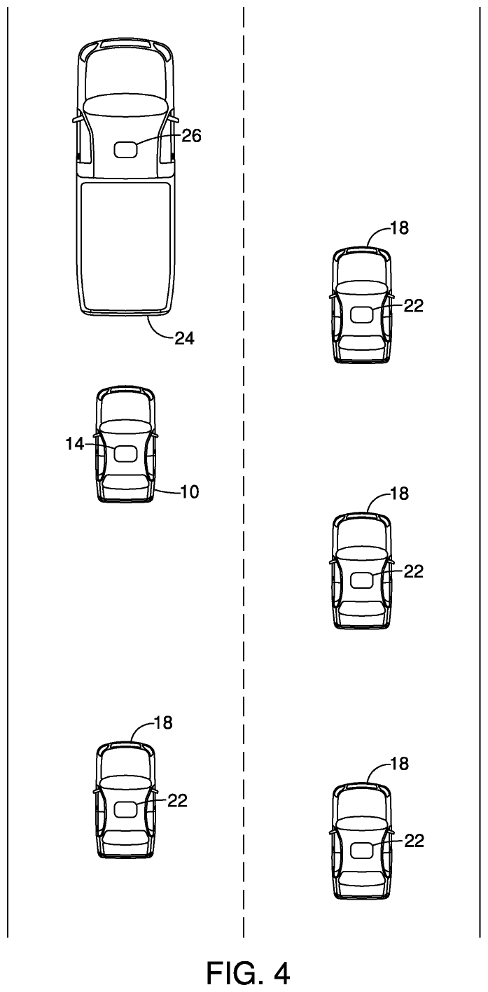

Referring initially to FIG. 1, a method of and system for transmitting a basic safety message (BSM) from a host vehicle 10 illustrated in accordance with an exemplary embodiment of the present invention. The basic safety message transmitting system 12 includes a wireless communication system 14 and a controller 16. The wireless communication system 14 is configured to broadcast the basic safety message to remote vehicles 18 (FIGS. 3 and 4) and to receive basic safety messages from the remote vehicles 18 within a predetermined distance of the host vehicle 10.

The wireless communication system 14 is a communication transceiver for performing a wireless communication with an external wireless communication device, such as the remote vehicles 18, as is understood in the art. The wireless communication system 14 communicates through any suitable standard, such as IEEE 802.11p or cellular, for communication over a wireless network.

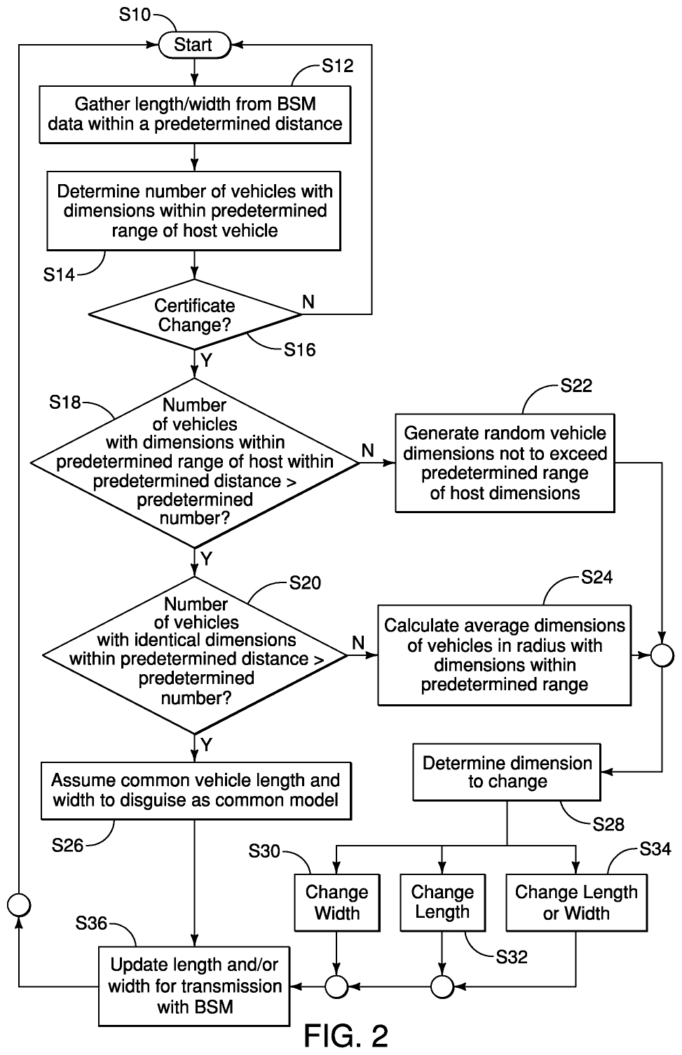

The controller 16 is preferably an electronic controller and includes a microcomputer with a control program to control components of the basic safety message transmitting system 12 as discussed below. The controller 16 can also include other conventional components such as an input interface circuit, an output interface circuit, and storage device(s) 20, such as a ROM (Read Only Memory) device and a RAM (Random Access Memory) device. The microcomputer of the controller 16 is at least programmed to control the basic safety message transmitting system 12 in accordance with the flowchart of FIG. 2 as discussed below. The microcomputer of the controller 16 is programmed to control the wireless communication system 14, and to make determinations or decisions, as discussed herein. The memory circuit stores processing results and control programs, such as ones for the wireless communication system 14, that are run by the processor circuit. The controller 16 is operatively coupled to the wireless communication system 14 in a conventional manner, as well as other electrical systems in the vehicle 10, such the turn signals, windshield wipers, lights and any other suitable systems. Such a connection enables the controller 16 to monitor and control any of these systems as desired. The internal RAM of the controller 16 stores statuses of operational flags and various control data. The internal ROM of the controller 16 stores the information for various operations. The controller 16 is capable of selectively controlling any of the components of the vehicle basic safety message transmitting system 12 in accordance with the control program. It will be apparent to those skilled in the art from this disclosure that the precise structure and algorithms for the controller 16 can be any combination of hardware and software that will carry out the functions of the present invention.

As shown in FIG. 1, the controller 16 can further include or be in communication with one or more storage devices 20 which can store information as discussed herein. The storage devices 20 can store information contained in the basic safety messages received from the remote vehicles 18 (FIGS. 3 and 4).

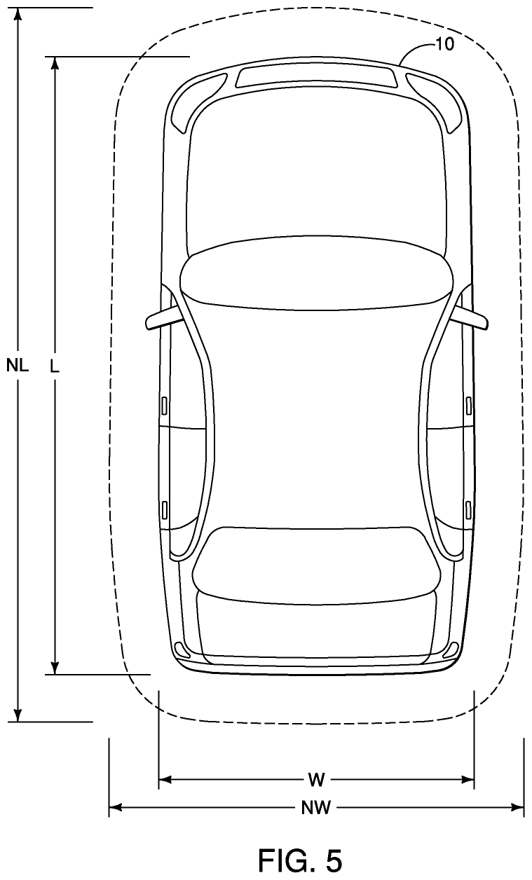

As shown in FIGS. 1 and 5, the host vehicle 10 has an actual length L and an actual width W. The actual length L and the actual width W are included in the basic safety message transmitted by the host vehicle 10 and each of the remote vehicles 18. Each of the remote vehicles 18 has an actual length RL and an actual width RW, as shown in FIG. 3, that is included in the basic safety message transmitted by the remote vehicle 18.

FIG. 2 illustrates a method of transmitting the basic safety message from the host vehicle 10 in accordance with an exemplary embodiment of the present invention. The basic safety message includes a security certificate to indicate that the transmitted basic safety message is from a trusted source. The basic safety message is transmitted by the host vehicle 10 at a predetermined frequency, such as ten times per second. The security certificate sent with the basic safety message is updated at a predetermined frequency, such as every five minutes. As described with reference to the flowchart of FIG. 2, the method and system to transmit a basic safety message in accordance with exemplary embodiments of the present invention changes the actual length and/or the actual width of the host vehicle transmitted with the basic safety message when the security certificate is changed, such that the changed, or new, length and/or width of the host vehicle is transmitted with the basic safety message to protect the privacy of the vehicle occupants of the host vehicle 10.

After the process starts (step S10), the host vehicle 10 (FIG. 1) gathers, or receives, the basic safety messages transmitted, or broadcast, from the remote vehicles 18 and 24 (FIGS. 3 and 4) within a predetermined distance in step S12. The basic safety message is a packet of data that includes information about the vehicle position, heading, speed, and other information relating to the vehicle's state and predicted path broadcast from a remote vehicle 18 and 24 transmitting a basic safety message, and also includes dimensions, such as length and width, of the transmitting vehicle. The remote vehicles 18 and 24 include a wireless communication system 22 and 26 (FIGS. 3 and 4), which are substantially similar to the wireless communication system 14 of the host vehicle 10, that transmit and receive the basic safety message. The predetermined distance is a distance or radius centered on the host vehicle 10, and is any distance through which the vehicle to vehicle communication can be established, such as three hundred meters. The transmitted basic safety messages from the remote vehicles 18 and 24 within the predetermined distance are received by the wireless communication system 14 of the host vehicle 10, and the information, such as the length and width of the transmitting remote vehicle 18 and 24, is stored in the storage device 20. The basic safety message transmitted by the host vehicle 10 is received by the wireless communication systems 22 and 26 of any remote vehicles 18 and 24 within the predetermined distance of the host vehicle 10.

The process then moves to step S14 in which the number of vehicles of the remote vehicles 18 and 24 that have both a width and a length within a predetermined range of the actual width and the actual length of the host vehicle 10 is determined from the received basic safety messages from the transmitting remote vehicles 18 and 24. The predetermined range can be any suitable range, such as, but not limited to, fifteen percent. The predetermined range is preferably ten percent. The predetermined range can also be a dimensional size difference, such as a predetermined length, such as 20 cm. Alternatively, the predetermined lengths for the predetermined ranges can be a different amount for the length and the width. The controller 16 determines the number of remote vehicles 18 and 24 within the predetermined distance that have a length RL and a width RW within the predetermined range of the actual length L and the actual width W of the host vehicle 10. The predetermined range captures lengths and widths greater than and less than the actual length L and width W of the host vehicle 10. In other words, the predetermined range is ±the predetermined percentage of the actual length L and width W of the host vehicle 10. The basic safety message is frequently broadcast (such as ten times per second), such that the controller 16 counts each unique remote vehicle 18 and 24 one time while the remote vehicle 18 and 24 remains within the predetermined range to avoid an erroneous count.

As shown in FIG. 3, the number of remote vehicles 18 having dimensions within the predetermined range of the host vehicle 10 is one in step S14. The remote vehicle 18 has dimensions within the predetermined range of the host vehicle 10, and the remote vehicle 24 has dimensions that are not within the predetermined range of the host vehicle 10. Thus, the number of remote vehicles in FIG. 3 having dimensions within the predetermined range of the host vehicle 10 is one.

As shown in FIG. 4, the number of remote vehicles 18 having dimensions within the predetermined range of the host vehicle 10 is four in step S14. Each of the remote vehicles 18 has dimensions within the predetermined range of the host vehicle 10, and the remote vehicle 24 has dimensions that are not within the predetermined range of the host vehicle 10. Thus, the number of remote vehicles in FIG. 4 having dimensions within the predetermined range of the host vehicle 10 is four.

In step S16, a determination is made whether a predetermined time period has elapsed such that the security certificate included with the basic safety message is to be changed. The security certificate is changed after the predetermined time period, such as five minutes, has elapsed. When the time period has elapsed and the security certificate is to be changed, the process moves to step S18. When the time period has not yet elapsed, the process returns to the start (step S10) and steps S12 and S14 are repeated until the time period to change the security certificate has elapsed.

When a determination is made that the security certificate needs to be changed in step S16, the process moves to step S18 in which a determination is made regarding how many remote vehicles 18 were determined to be within the predetermined distance and to have vehicle dimensions within the predetermined range of the actual dimensions of the host vehicle 10. The total count is indicative of the density of similarly sized remote vehicles within the predetermined distance of the host vehicle 10. When the number determined in step S18 is greater than a predetermined number (i.e., a high density), the process moves to step S20. When the number determined in step S18 is equal to or fewer than the predetermined number (i.e., a low density), the process moves to step S22. The predetermined number in step S18 can be any suitable number, such as three.

In step S20, the number of remote vehicles 18 that have identical dimensions (i.e., length and width) as the host vehicle 10 is determined from the number of remote vehicles 18 determined in step S18. When the number determined in step S20 is greater than a predetermined number (i.e., a high density of identical vehicles), the process moves to step S26. When the number determined in step S20 is equal to or fewer than the predetermined number (i.e., a low density of identical vehicles), the process moves to step S24. The predetermined number in step S20 can be any suitable number, such as three.

In steps S22, S24 and S26, a new length and/or a new width of the host vehicle 10 is determined based on the number of remote vehicles 18 determined in steps S18 and S20. The at least one of the new width and the new length of the host vehicle 10 is based on the received basic safety messages from the remote vehicles 18. The new length and/or new width is stored in the storage device 20 and transmitted with the basic safety message broadcast by the host vehicle 10. The new length and/or the new width is transmitted until the next security certificate change is determined in step S16, and another new length and/or new width is determined and is transmitted with the basic safety message. The new length and/or width transmitted with the basic safety message prevents identification and tracking of the host vehicle 10, thereby protecting the privacy of the vehicle occupants of the host vehicle 10.

In step S22, a new length and/or new width is determined based on the number of remote vehicles 18 determined in step S18. The new length and/or new width is randomly generated to not exceed a predetermined range of the dimensions of the host vehicle 10. For example, when the predetermined range is ten percent, the new length and/or new width can be any value greater than zero and less than or equal to ten. The new length and/or the new width is then calculated by multiplying the actual length and/or the actual width by the predetermined range, such as ten percent, to determine the new length and/or the new width of the host vehicle 10 to be transmitted with the basic safety message.

Alternatively, in step S22, the new length and/or the new width can be any random number up to a predetermined value that is added to the actual length and/or actual width of the host vehicle 10. For example, the predetermined value can be up to and including twenty centimeters. A random value of ten can be determined by the controller 16, and ten centimeters is added to the actual length and/or actual width of the host vehicle 10 for the new length and/or new width of the host vehicle to be transmitted with the basic safety message.

In step S24, a new length and/or new width is calculated based on the number of remote vehicles 18 determined in step S20. The calculated new length and/or new width is the average of the length and/or width, respectively, of the number of remote vehicles 18 determined in step S20. The calculated new length and/or new width of the host vehicle is transmitted with the basic safety message.

In step S26, a new length and a new width are determined based on the number of remote vehicles 18 determined in step S20. The new length and the new width are selected from lengths and widths of vehicles stored in the storage device 20. The stored lengths and widths correspond to actual lengths and actual widths of vehicles that are a different make and model than the host vehicle 10. In step S26, both the actual length and the actual width of the host vehicle 10 are changed to the length and width of a vehicle stored in the storage device 20 that is different from the make and model of the host vehicle 10. Alternatively, the actual length and the actual width of the host vehicle 10 can be changed to the length and width of one of the remote vehicles 18. The new length and the new width are different from and preferably larger than the actual length and the actual width of the host vehicle 10. The new length and the new width of the host vehicle 10 are transmitted with the basic safety message. Alternatively, only one of the actual width and the actual length of the host vehicle 10 is changed in step S26.

After a new length and/or new width is determined in steps S22 and S24, the process moves to step S28 to determine whether the actual length L and/or the actual width W are to be updated with the new length and/or new width determined it steps S22 and S24. The process moves to step S30 when only the actual width W of the host vehicle is being changed. The process moves to step S32 when only the actual length of the host vehicle 10 is being changed. The process moves to step S34 when both the actual length L and the actual width W are being changed.

The determination in step S28 regarding whether to change the width (step S30), change the length (step S32), or change both the width and the length (step S34) can be based on any suitable algorithm. For example, a random number generator that generates either the number one, two or three can be used. When the random number generator returns the number one, the process moves to step S30. When the random number generator returns the number two, the process moves to step S32. When the random number generator returns the number three, the process moves to step S34.

As shown in step S30, the actual width W is changed to the new width NW, and the actual length L is not changed. The vehicle dimensions transmitted with the basic safety message until the next security certificate change are the new width NW and the actual length L. This change of a dimension of the host vehicle 10 prevents the host vehicle 10 from being identified and the protects the privacy of the vehicle occupants of the host vehicle 10.

As shown in step S32, the actual length L is changed to the new length NL, and the actual width W is not changed. The vehicle dimensions transmitted with the basic safety message until the next certificate change are the actual width W and the new length NL. This change of a dimension of the host vehicle 10 prevents the host vehicle 10 from being identified and the protects the privacy of the vehicle occupants of the host vehicle 10.

As shown in step S34, the actual length is changed to the new length NL and the actual width W is changed to the new width NW. The vehicle dimensions transmitted with the basic safety message until the next security certificate change are the new width NW and the new length NL. This change of dimensions of the host vehicle 10 prevents the host vehicle 10 from being identified and the protects the privacy of the vehicle occupants of the host vehicle 10.

As shown in FIG. 5, the actual dimensions of the host vehicle 10 are shown with solid lines and the changed, or new, dimensions of the vehicle are shown with dashed lines. The new length NL and the new width NW are larger than the actual length L and the actual width W of the host vehicle 10.

Following steps S26, S30, S32 and S34, the process moves to step S36 in which the actual length and/or the actual width of the host vehicle 10 is changed to the new length and/or the new width to be included with the transmitted basic safety message until the next security certificate change (step S16). The new length NL and/or the new width NW is stored in the storage device 20. The process returns to the start S10 of the process, and repeats steps S12 and S14 until the next security certificate change is required in step S16. When a security certificate change is required in step S16, a new length and/or a new width is determined in accordance with steps S18-S36. The basic safety message transmitting system 12 in accordance with exemplary embodiments of the present invention frequently changes the dimensions of the host vehicle 10 during operation of the host vehicle 10 to protect the privacy of the vehicle occupants of the host vehicle 10.

When the actual length and/or the actual width of the host vehicle 10 is changed in accordance with exemplary embodiments of the present invention, the new length and/or the new width are preferably larger than the actual length and/or actual width, respectively. The new width NW (FIG. 5) of the vehicle is preferably less than a lane width LW (FIG. 3) of a road 28 being traveled by the host vehicle 10.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the method of and system for transmitting a basic safety message from a vehicle. Accordingly, these terms, as utilized to describe the present invention should be interpreted relative to a vehicle equipped with the method of and system for transmitting a basic safety message from a vehicle.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A method of transmitting a vehicle basic safety message comprising:
receiving a basic safety message from each of a plurality of remote vehicles within a predetermined distance of a host vehicle, the basic safety message including a width and a length of the remote vehicle;
determining at least one of a new width and a new length of the host vehicle, the new width and the new length of the host vehicle being different from an actual width and an actual length of the host vehicle; and
transmitting a new basic safety message from the host vehicle including the at least one of the new width and the new length of the host vehicle.

2. The method of transmitting a vehicle basic safety message according to claim 1, wherein
the predetermined distance is approximately three hundred meters.

3. The method of transmitting a vehicle basic safety message according to claim 1, wherein
determining the at least one of the new width and the new length of the host vehicle is based on the received basic safety messages.

4. The method of transmitting a vehicle basic safety message according to claim 3, further comprising
determining a number of vehicles of the remote vehicles having both a width and a length within a predetermined range of the actual width and the actual length of the host vehicle from the received basic safety messages.

5. The method of transmitting a vehicle basic safety message according to claim 4, wherein
the new width and the new length determined for the host vehicle is an average of the widths and the lengths of the remote vehicles within the predetermined range when the number is larger than a predetermined number.

6. The method of transmitting a vehicle basic safety message according to claim 5, wherein
the predetermined number is three.

7. The method of transmitting a vehicle basic safety message according to claim 4, wherein
the new width and the new length determined for the host vehicle is a random length added to the actual width and the actual length of the host vehicle when the number is less than or equal to a predetermined number.

8. The method of transmitting a vehicle basic safety message according to claim 7, wherein
the predetermined number is three.

9. The method of transmitting a vehicle basic safety message according to claim 7, wherein
the random length is less than or equal to twenty centimeters.

10. The method of transmitting a vehicle basic safety message according to claim 4, wherein
the predetermined range is approximately ten percent.

11. The method of transmitting a vehicle basic safety message according to claim 1, further comprising generating a random number between one and three,
transmitting the new basic safety message includes the new width when the random number is one,
transmitting the new basic safety message includes the new length when the random number is two, and
transmitting the new basic safety message includes the new width and the new length when the random number is three.

12. The method of transmitting a vehicle basic safety message according to claim 1, wherein
the at least one of the new width and the new length of the host vehicle is selected from widths and lengths stored in a memory.

13. The method of transmitting a vehicle basic safety message according to claim 1, wherein
the at least one of the new width and the new length of the host vehicle is selected from a width and a length of one of the remote vehicles, the at least one of the new width and the new length being different from and larger than the actual width and the actual length of the host vehicle.

14. The method of transmitting a vehicle basic safety message according to claim 1, wherein
a width and length information included with the basic safety message is updated after a predetermined amount of time.

15. The method of transmitting a vehicle basic safety message according to claim 14, wherein
the predetermined amount of time is approximately five minutes.

16. The method of transmitting a vehicle basic safety message according to claim 1, wherein
the new width and the new length of the host vehicle are larger than the actual width and the actual length of the host vehicle.

17. A system for transmitting a vehicle basic safety message, the system comprising:
a wireless communication system configured to receive a remote vehicle basic safety message from each of a plurality of remote vehicles within a predetermined distance of a host vehicle, the remote vehicle basic safety message including a width and a length of the remote vehicle;
an electronic controller configured to determine at least one of a new width and a new length of the host vehicle, the new width and the new length of the host vehicle being different from an actual width and an actual length of the host vehicle; and
the wireless communication system being further configured to transmit a host vehicle basic safety message including the at least one of the new width and the new length of the host vehicle.

18. The system for transmitting a vehicle basic safety message according to claim 17, wherein
the new width and the new length of the host vehicle are larger than the actual width and the actual length of the host vehicle.

19. The system for transmitting a vehicle basic safety message according to claim 17, wherein
the at least one of the new width and the new length of the host vehicle is determined based on the received remote vehicle basic safety messages.

20. The system for transmitting a vehicle basic safety message according to claim 17, wherein
the controller updates the new width and the new length of the host vehicle after a predetermined amount of time.
